(19) United States
(12) Patent Application Publication
(10) Pub. No.: US 2024/0386080 A1
(43) Pub. Date: Nov. 21, 2024

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Kazuko KIRIHARA, Kanagawa (JP)

(73) Assignee: FUJIFILM Business Innovation Corp., Tokyo (JP)

(21) Appl. No.: 18/505,771

(22) Filed: Nov. 9, 2023

(30) Foreign Application Priority Data
May 17, 2023 (JP) 2023-081437

(51) Int. Cl. G06F 21/31; G06F 21/60

(52) U.S. Cl. CPC G06F 21/31; G06F 21/608

(57) ABSTRACT

An information processing system includes one or more processors configured to: identify a first user who has been authenticated in first authentication to remotely connect, using a terminal, to an image processing apparatus and a second user who wishes to be authenticated in second authentication to use the image processing apparatus; and determine, based on information indicating a relationship between the identified first user and the identified second user, whether or not to permit the second authentication of the second user.

### CROSS-REFERENCE TO RELATED APPLICATIONS

This application is based on and claims priority under 35 USC 119 from Japanese Patent Application No. 2023-081437 filed May 17, 2023.

### BACKGROUND

### (i) Technical Field

The present disclosure relates to an information processing system, an information processing method, and a non-transitory computer readable medium.

### (ii) Related Art

As a technique for allowing a plurality of users to use an image processing apparatus such as a so-called multifunction machine capable of processing including reading and printing of documents, a technique for performing authentication using an authentication apparatus connected to (or integrated with) the image processing apparatus has been known (for example, Japanese Patent No. 6044167). In the technique mentioned above, seamless authentication by, for example, an operation for holding a card medium, a mobile terminal, or the like carried by a user over the authentication apparatus is implemented.

Furthermore, a technique for connecting a mobile terminal to an image processing apparatus so that a remote operation is able to be performed has also been known (for example, Japanese Unexamined Patent Application Publication No. 2008-193528). In the technique mentioned above, two-step authentication including first authentication to remotely connect the mobile terminal to the image processing apparatus and second authentication to use the image processing apparatus is performed. The second authentication requires, for example, an operation for entering authentication information (ID, password, etc.) on a login screen displayed on the mobile terminal.

Typically, a remote operation from a mobile terminal is often performed when the mobile terminal is in a distant location. However, there is an increasing number of cases where a mobile terminal located near the image processing apparatus performs a remote operation. Therefore, if the second authentication described above is able to be performed using the authentication apparatus connected to the image processing apparatus, the operation for entering authentication information on the login screen displayed on the mobile terminal is able to be omitted. Thus, the convenience of the user who wishes to perform a remote operation for the image processing apparatus from a location near the image processing apparatus is improved.

### SUMMARY

However, a technique for allowing the first authentication for remotely connecting the mobile terminal to the image processing apparatus and authentication using the authentication apparatus to work together is not established. Therefore, even after the first authentication of a user who wishes to perform a remote operation is successful, authentication of a different user who performs authentication using the authentication apparatus may be permitted. Thus, a remote operation by the user who connects the mobile terminal to the image processing apparatus may be interrupted by the different user.

Aspects of non-limiting embodiments of the present disclosure relate to preventing a remote operation by a user who remotely connects a mobile terminal to an image processing apparatus from being interrupted by a different user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or more processors configured to: identify a first user who has been authenticated in first authentication to remotely connect, using a terminal, to an image processing apparatus and a second user who wishes to be authenticated in second authentication to use the image processing apparatus; and determine, based on information indicating a relationship between the identified first user and the identified second user, whether or not to permit the second authentication of the second user.

### BRIEF DESCRIPTION OF THE DRAWINGS

Exemplary embodiments of the present disclosure will be described in detail based on the following figures, wherein:

FIG. 1 is a diagram illustrating an example of the entire configuration of an information processing system to which an exemplary embodiment is applied;

FIG. 2 is a diagram illustrating an example of the hardware configuration of an image processing apparatus;

FIG. 3 is a diagram illustrating an example of the functional configuration of a controller of the image processing apparatus;

FIG. 4 is a diagram illustrating an example of the functional configuration of a controller of a user terminal;

FIG. 5 is a flowchart illustrating the flow of a process of the image processing apparatus;

FIG. 6 is a diagram illustrating a specific example of information indicating that a first user and a second user are the same;

FIG. 7 is a diagram illustrating a specific example of the relationship between the first user and the second user;

FIG. 8 is a diagram illustrating a specific example of the relationship between the first user and the second user; and

FIG. 9 is a diagram illustrating a specific example of the relationship between the first user and the second user.

### DETAILED DESCRIPTION

Hereinafter, exemplary embodiments of the present disclosure will be described in detail with reference to accompanying drawings.

### <Configuration of Information Processing System>

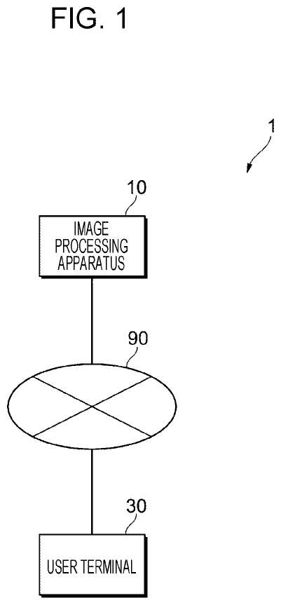

FIG. 1 is a diagram illustrating an example of the entire configuration of an information processing system 1 to which an exemplary embodiment is applied.

The information processing system 1 is configurated in such a manner that an image processing apparatus 10 and a user terminal 30 are connected via a network 90. The network 90 is, for example, a local area network (LAN), the Internet, or the like.

### (Image Processing Apparatus)

The image processing apparatus 10 is an information processing apparatus that performs various types of processing in accordance with input operations from a user who uses the information processing system 1. For example, the image processing apparatus 10 performs processing for forming an image on a medium such as paper, processing for outputting a recording medium on which an image is formed, and processing for reading an image formed on paper or other media. The image processing apparatus 10 is, for example, a multifunction machine of a so-called electrophotographic system that forms a toner image on a printing surface of paper, a printer of a so-called inkjet system that discharges ink to a printing surface of paper, or the like.

Furthermore, the image processing apparatus 10 acquires various types of information transmitted from the user terminal 30 and performs various types of processing. The image processing apparatus 10 also transmits various types of information to the user terminal 30. For example, the image processing apparatus 10 identifies a user (hereinafter, referred to as a “first user”) who has been authenticated in authentication (hereinafter, referred to as “first authentication”) to remotely connect, using the user terminal 30, to the image processing apparatus 10 and a user (hereinafter, referred to as a “second user”) who wishes to be authenticated in authentication (hereinafter, referred to as “second authentication”) to use the image processing apparatus 10. In the case where there is no need to distinguish between the first user and the second user, these users will be simply referred to as “users”.

Furthermore, the image processing apparatus 10 determines, based on information indicating the relationship between the identified first user and the identified second user, whether or not to permit the second authentication of the second user. The “information indicating the relationship between the first user and the second user” represents, for example, information indicating that the first user and the second user are the same, information indicating that the first user and the second user have a predetermined relationship, or the like. Specific examples of the information indicating that the first user and the second user are the same and the information indicating that the first user and the second user have a predetermined relationship will be described later.

Furthermore, the image processing apparatus 10 identifies, based on information that has been input to the user terminal 30 and used for the first authentication and information read by an authenticating unit of the image processing apparatus 10, the first user and the second user. The “authenticating unit” is, for example, an authentication terminal apparatus that is connected to the image processing apparatus 10 or integrated with the image processing apparatus 10. The authentication terminal apparatus is, for example, an apparatus using a near field communication (NFC) technique. The details of the configuration and processing of the image processing apparatus 10 will be described later.

### (User Terminal)

The user terminal 30 is a mobile information processing apparatus such as a smartphone or a tablet terminal operated by a user who uses the information processing system 1. Application software that allows the user terminal 30 to operate the image processing apparatus 10 is installed in the user terminal 30. The user terminal 30 acquires various types of information transmitted from the image processing apparatus 10 and performs various types of processing. The user terminal 30 also transmits various types of information to the image processing apparatus 10. For example, the user terminal 30 receives input information to be used for the first authentication and transmits the input information to the image processing apparatus 10. The details of the configuration and processing of the user terminal 30 will be described later.

The configuration of the information processing system 1 described above is merely an example, and the information processing system 1, only as a whole, needs to have functions for implementing the processing described above. Thus, part of or all the functions for implementing the processing described above may be distributed inside the information processing system 1 or may cooperate with each other. That is, part of or all the functions of the user terminal 30 may be provided as functions of the image processing apparatus 10 or part of or all the functions of the image processing apparatus 10 may be provided as functions of the user terminal 30. Furthermore, part of or all the functions of each of the user terminal 30 and the image processing apparatus 10 forming the information processing system 1 may be transferred to a server or other devices not illustrated in the drawing. Thus, processing as the entire information processing system 1 is promoted and a plurality of types of processing may complement each other.

### (Hardware Configuration of Image Processing Apparatus)

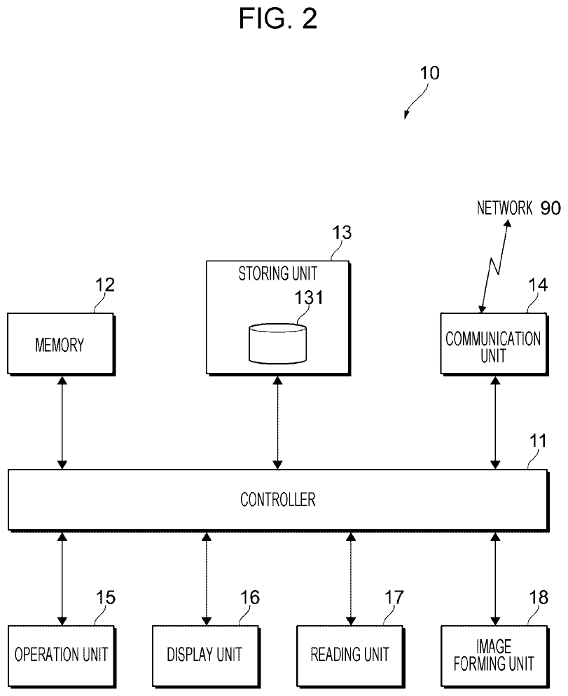

FIG. 2 is a diagram illustrating an example of the hardware configuration of the image processing apparatus 10.

The image processing apparatus 10 includes a controller 11, a memory 12, a storing unit 13, a communication unit 14, an operation unit 15, a display unit 16, a reading unit 17, and an image forming unit 18. These units are connected to one another via a data bus, an address bus, a peripheral component interconnect (PCI) bus, or the like.

The controller 11 is a processor that controls functions of the user terminal 30 by executing various types of software such as an operating system (OS) (basic software) and application software. The controller 11 includes, for example, a central processing unit (CPU). The memory 12 is a storage region in which various types of software, data used for execution of the various types of software, and the like are stored and is used as a work area when operation is performed. The memory 12 includes, for example, a random access memory (RAM).

The storing unit 13 is a storage region in which input data for various type of software, output data from various types of software, and the like are stored. The storing unit 13 includes, for example, a hard disk drive (HDD), a solid state drive (SSD), a semiconductor memory, and the like used for storing a program, various setting data, and the like. In the storing unit 13, as a database (DB) that stores various types of information, for example, a user DB 131 in which information about users (hereinafter, referred to as “user information”) is stored, or the like is stored.

The communication unit 14 performs data transmission and reception between the user terminal 30 and an external apparatus via the network 90. The operation unit 15 includes, for example, a software keyboard, a mechanical button, a switch, and the like and receives input operations. The operation unit 15 also includes a touch sensor. The touch sensor and the display unit 16 are integrated to form a touch panel. The display unit 16 is, for example, a liquid crystal display or an organic electroluminescence (EL) display used for displaying information and displays image or text data.

The reading unit 17 reads an image recorded on a medium such as paper as a recording medium (for example, a document of a paper medium). The reading unit 17 includes, for example, a scanner of a charge coupled devices (CCD) type that reduces, with a lens, reflected light with respect to light radiated from a light source to a document and receives, with CCD, the light, a scanner of a contact image sensor (CIS) type that receives, with a CIS, reflected light with respect to light sequentially radiated from a light-emitting diode (LED) light source to a document, or the like. The image forming unit 18 forms an image to be printed on a printing surface of paper as a recording medium by, for example, an electrophotographic system or an inkjet system. These units are connected to one another via a data bus, an address bus, a PCI bus, or the like.

### (Hardware Configuration of User Terminal)

The hardware configuration of the user terminal 30 is similar to the hardware configuration of the image processing apparatus 10 illustrated in FIG. 2 with the exception of the reading unit 17 and the image forming unit 18. That is, the user terminal 30 includes a controller, a memory, a storing unit, a communication unit, an operation unit, and a display unit having functions similar to functions of the controller 11, the memory 12, the storing unit 13, the communication unit 14, the operation unit 15, and the display unit 16 illustrated in FIG. 2, and illustration and description of the similar units will be omitted.

### (Functional Configuration of Controller of Image Processing Apparatus)

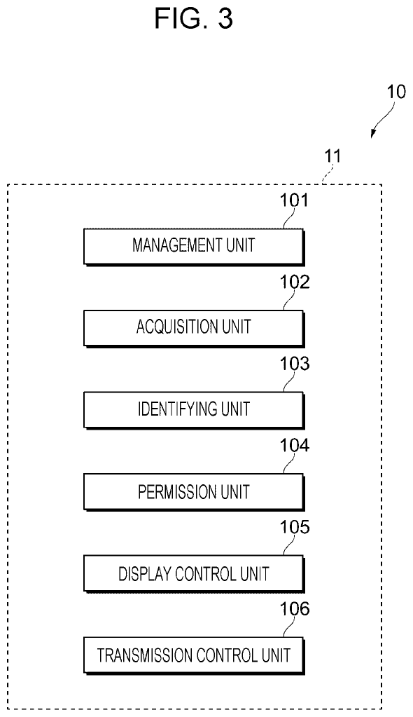

FIG. 3 is a diagram illustrating an example of the functional configuration of the controller 11 of the image processing apparatus 10.

In the controller 11 of the image processing apparatus 10, a management unit 101, an acquisition unit 102, an identifying unit 103, a permission unit 104, a display control unit 105, and a transmission control unit 106 function.

The management unit 101 stores various types of information in the database of the storing unit 13 (see FIG. 2) and manages the various types of information. For example, the management unit 101 stores user information in the user DB 131 and manages the user information. The user information managed by the management unit 101 includes identification information that is able to uniquely identify a user (for example, a user ID, biometric information, etc.), a user name, identification information (for example, a card ID) that is able to uniquely identify a card (hereinafter, referred to as an authentication card) for the second authentication distributed to the user, the scope of a permission granted to the user, and the like.

The acquisition unit 102 acquires various types of information. For example, the acquisition unit 102 acquires input information received by the operation unit 15 of the image processing apparatus 10. Furthermore, for example, the acquisition unit 102 also acquires various types of information transmitted from the user terminal 30 and an external apparatus. Among a plurality of types of information acquired by the acquisition unit 102, information transmitted from the user terminal 30 includes, for example, input information input to the user terminal 30. The input information acquired by the acquisition unit 102 is, for example, information used for the first authentication of the first user, information input to perform a remote operation for the image processing apparatus 10, or the like.

The identifying unit 103 identifies the first user who has been authenticated in the first authentication. Specifically, the identifying unit 103 identifies the first user on the basis of information that has been used for the first authentication. Furthermore, the identifying unit 103 identifies the second user who wishes to be authenticated in the second authentication to use the image processing apparatus 10. Specifically, the identifying unit 103 identifies the second user on the basis of information read by the authenticating unit of the image processing apparatus 10.

The permission unit 104 determines whether or not to permit the second authentication of the second user. Specifically, the permission unit 104 determines whether or not to permit the second authentication of the second user on the basis of information indicating the relationship between the first user and the second user identified by the identifying unit 103. For example, the permission unit 104 permits the second authentication of the second user on the basis of information indicating that the second user is the first user, as information indicating the relationship between the first user and the second user. The information indicating that the second user is the first user is, for example, information indicating that the first user and the second user are the same because both the first user and the second user have the same identification information such as a user ID.

Furthermore, the permission unit 104 determines whether or not to permit the second authentication of the second user on the basis of information indicating that the first user and the second user are in a relationship in which the second user is not the first user but the second authentication of the second user may be permitted, as information indicating the relationship between the first user and the second user. For example, in the case where the second user who does not have an administrator permission is permitted the first authentication by using the administrator permission that the first user has and then permitted the second authentication by using the permission that the second user has, the relationship in which the second user is not the first user but the second authentication of the second user may be permitted is satisfied. Furthermore, in the case where a user who has a plurality of pieces of identification information such as an ID that is able to uniquely identify a user uses different pieces of identification information for the first authentication and the second authentication, since the second user and the first user are formally not the same but are practically the same, the relationship in which the second authentication of the second user may be permitted is satisfied.

Furthermore, the permission unit 104 permits the second authentication of the second user on the basis of information indicating that the second user has confirmed that the first user and the second user are in a relationship in which the second user is not the first user but the second authentication of the second user may be permitted. The information indicating that the second user has confirmed that the first user and the second user are in a relationship in which the second user is not the first user but the second authentication of the second user may be permitted is, for example, information indicating that a button to be pressed by the second user at the time when the second user confirms that the first user and the second user are in a relationship in which the second user is not the first user but the second authentication of the second user may be permitted has been pressed.

Furthermore, the permission unit 104 permits the second authentication of the second user on the basis of information indicating that the first user has confirmed that the first user and the second user are in a relationship in which the second user is not the first user but the second authentication of the second user may be permitted. The information indicating that the first user has confirmed that the first user and the second user are in a relationship in which the second user is not the first user but the second authentication of the second user may be permitted is, for example, information indicating that a button to be pressed by the first user at the time when the first user confirms that the first user and the second user are in a relationship in which the second user is not the first user but the second authentication of the second user may be permitted has been pressed.

Furthermore, the permission unit 104 determines whether or not to permit the second user to use the authenticating unit of the image processing apparatus 10. For example, in the case where the authenticating unit functions as a charging unit that is not capable of identifying the second user, the permission unit 104 does not permit the second user to use the authenticating unit of the image processing apparatus 10. The “charging unit” is, for example, a payment processing terminal that is connected to or integrated with the image processing apparatus 10. The payment processing terminal is, for example, an apparatus using the NFC technique.

The display control unit 105 performs control for displaying various types of information on the display unit 16 (see FIG. 2). For example, the display control unit 105 performs control for displaying on the display unit 16 information for allowing the second user to confirm that the first user and the second user are in a relationship in which the second user is not the first user but the second authentication of the second user may be permitted. The information for allowing the second user to confirm that the first user and the second user are in a relationship in which the second user is not the first user but the second authentication of the second user may be permitted is, for example, a confirmation button.

Furthermore, at the time when the display control unit 105 displays on the display unit 16 information for allowing the second user to confirm that the first user and the second user are in a relationship in which the second user is not the first user but the second authentication of the second user may be permitted, in the case where an operation for the operation screen of the image processing apparatus 10 is restricted due to remote connection between the image processing apparatus 10 and the user terminal 30, the display control unit 105 temporarily removes the restriction.

Furthermore, the display control unit 105 performs control for displaying on the user terminal 30 information for allowing the first user to confirm that the first user and the second user are in a relationship in which the second user is not the first user but the second authentication of the second user may be permitted. The information for allowing the first user to confirm that the first user and the second user are in a relationship in which the second user is not the first user but the second authentication of the second user may be permitted is, for example, a confirmation button.

Furthermore, in the case where the authenticating unit of the image processing apparatus 10 functions as a charging unit that is not capable of identifying the second user, when money is inserted into the charging unit, the display control unit 105 performs control for displaying on the display unit 16 information for allowing the second user to confirm whether or not to permit reception of the inserted money. The information for allowing the second user to confirm whether or not to permit reception of inserted money is, for example, a confirmation button.

The transmission control unit 106 performs control for transmitting various types of information via the communication unit 14 (see FIG. 2). Specifically, the transmission control unit 106 performs control for transmitting various types of information to the user terminal 30 and an external apparatus. For example, the transmission control unit 106 performs control for transmitting control information for displaying various types of information on the user terminal 30. The control information for displaying various types of information on the user terminal 30 is, for example, control information for displaying on the user terminal 30 information for allowing the first user to confirm that the first user and the second user are in a relationship in which the second user is not the first user but the second authentication of the second user may be permitted.

### (Functional Configuration of Controller of User Terminal)

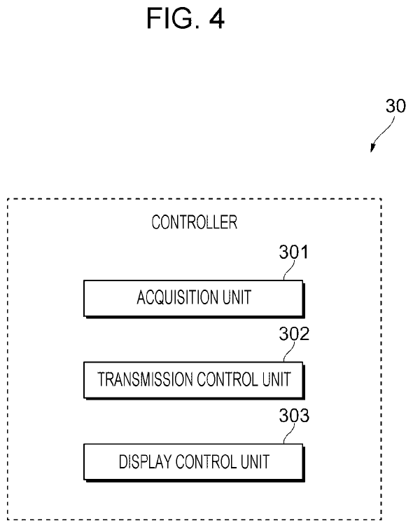

FIG. 4 is a diagram illustrating an example of the functional configuration of the controller of the user terminal 30.

In the controller of the user terminal 30, an acquisition unit 301, a transmission control unit 302, and a display control unit 303 function.

The acquisition unit 301 acquires various types of information. For example, the acquisition unit 301 acquires input information received by the operation unit of the user terminal 30. Furthermore, for example, the acquisition unit 301 acquires various types of information transmitted from the image processing apparatus 10 and an external apparatus. Among a plurality of types of information acquired by the acquisition unit 301, information transmitted from the image processing apparatus 10 includes, for example, control information for displaying on the user terminal 30 information for allowing the first user to confirm that the first user and the second user are in a relationship in which the second user is not the first user but the second authentication of the second user may be permitted.

The transmission control unit 302 performs control for transmitting various types of information via the communication unit. Specifically, the transmission control unit 302 performs control for transmitting various types of information to the image processing apparatus 10 and an external apparatus. For example, the transmission control unit 302 performs control for transmitting input information acquired by the acquisition unit 301 to the image processing apparatus 10. The input information transmitted to the image processing apparatus 10 is, for example, information to be used for the first authentication, information input to perform a remote operation for the image processing apparatus 10, or the like.

The display control unit 303 performs control for displaying various types of information on the display unit. For example, the display control unit 303 performs control for displaying the operation screen of the image processing apparatus 10 on the display unit of the user terminal 30 in a shared manner. Furthermore, the display control unit 303 performs control for displaying on the display unit information for allowing the first user to confirm that the first user and the second user are in a relationship in which the second user is not the first user but the second authentication of the second user may be permitted.

### <Flow of Process>

### (Flow of Process of Image Processing Apparatus)

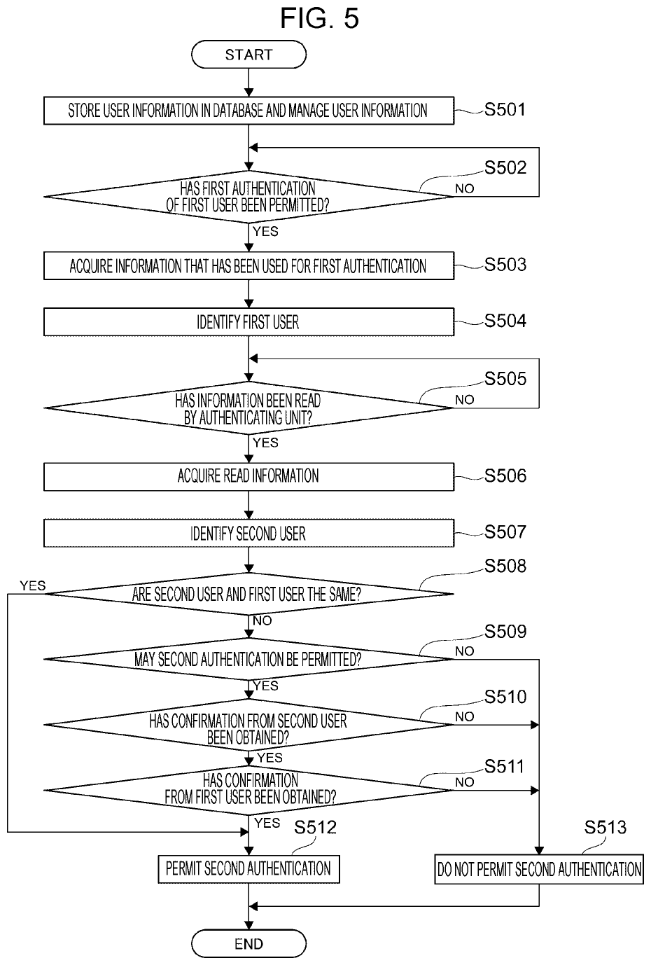

FIG. 5 is a flowchart illustrating the flow of a process of the image processing apparatus 10.

The image processing apparatus 10 stores user information in the database and manages the user information (step 501). Specifically, the image processing apparatus 10 stores user information in the user DB 131 of the storing unit 13 (see FIG. 2) and manages the user information.

Next, when the first authentication of the first user is permitted (YES in step 502), the image processing apparatus 10 acquires information that has been used for the first authentication (step 503). For example, the image processing apparatus 10 acquires, as the information that has been used for the first authentication, a user ID of the first user. Then, the image processing apparatus 10 identifies the first user who has been authenticated in the first authentication, on the basis of the information that has been used for the first authentication of the first user acquired in step 503 (step 504). In contrast, in the case where the first authentication of the first user is not permitted (NO in step 502), the image processing apparatus 10 repeats the determination processing of step 502 until the first authentication of the first user is permitted.

Next, when information is read by the authenticating unit of the image processing apparatus 10 (YES in step 505), the image processing apparatus 10 acquires the read information (step 506). Then, the image processing apparatus 10 identifies, based on the information acquired in step 506, the second user who wishes to be authenticated in the second authentication (step 507). In contrast, in the case where information is not read by the authenticating unit of the image processing apparatus 10 (NO in step 505), the image processing apparatus 10 repeats the determination processing of step 505 until information is read by the authenticating unit of the image processing apparatus 10.

Next, in the case where it is determined, on the basis of the relationship between the first user and the second user identified in step 507, that the second user is the first user (YES in step 508), the image processing apparatus 10 permits the second authentication of the second user (step 512). In the case where the second user is not the first user (NO in step 508) but the second authentication of the second user may be permitted on the basis of the relationship between the first user and the second user (YES in step 509), the image processing apparatus 10 proceeds to determination processing of step 510. In contrast, in the case where the second user is not the first user (NO in step 508) and the first user and the second user are not in a relationship in which the second authentication of the second user may be permitted (NO in step 509), the image processing apparatus 10 does not permit the second authentication of the second user (step 513).

In the case where the confirmation that the second authentication of the second user may be permitted is obtained from the second user (YES in step 510), the image processing apparatus 10 proceeds to determination processing of step 511. That is, in the case where the second user has confirmed that the first user and the second user are in a relationship in which the second user is not the first user but the second authentication of the second user may be permitted, the second authentication of the second user is permitted. In contrast, in the case where the confirmation that the second authentication of the second user may be permitted is not obtained from the second user (NO in step 510), the image processing apparatus 10 does not permit the second authentication of the second user (step 513).

In the case where the confirmation that the second authentication of the second user may be permitted is obtained from the first user (YES in step 511), the image processing apparatus 10 permits the second authentication of the second user (step 512). That is, in the case where the first user has confirmed that the first user and the second user are in a relationship in which the second user is not the first user but the second authentication of the second user may be permitted, the second authentication of the second user is permitted. In contrast, in the case where the confirmation that the second authentication of the second user may be permitted is not obtained from the first user (NO in step 511), the image processing apparatus 10 does not permit the second authentication of the second user (step 513).

### Specific Examples

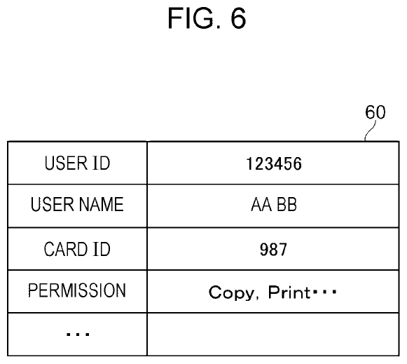

FIG. 6 is a diagram illustrating a specific example of information indicating that the first user and the second user are the same.

In FIG. 6, as a specific example of information indicating that the first user and the second user are the same, information displayed on an authentication card 60 distributed to a user, is illustrated. The authentication card 60 is a card created for each user ID as identification information that is able to uniquely identify a user. On the authentication card 60, information including a user ID, a user name, a card ID, and the scope of a permission is displayed. The authentication card 60 illustrated in FIG. 6 indicates that, for example, the user ID is “123456”, the user name is “AA BB”, the card ID is “987”, and the scope of permission is “Copy, Print, . . . ”.

A user may have a single authentication card 60 or may have a plurality of authentication cards 60. In the case where a single user has a plurality of authentication cards 60, a plurality of user IDs belong to the single user. In this case, a user is identified based on various types of information (for example, a user name) associated with the authentication cards 60.

For example, it is assumed that, among the plurality of types of information displayed on the authentication card 60 illustrated in FIG. 6, the information used for the first authentication is the user ID and the information used for the second authentication is the card ID. In this case, when it is identified that the user ID of the first user who is authenticated in the first authentication is “123456” and the card ID read from the authentication card 60 of the second user who wishes to be authenticated in the second authentication is “987”, the second user who wishes to be authenticated in the second authentication is identified as the first user who has been authenticated in the first authentication, and the second authentication of the second user is permitted.

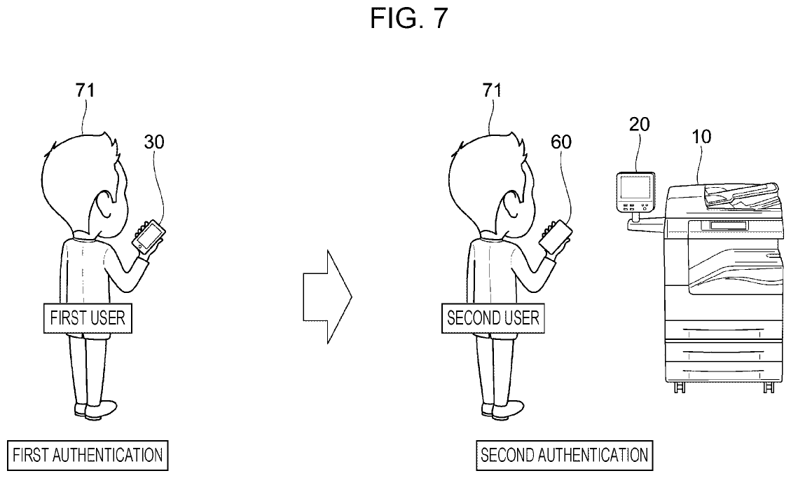

FIGS. 7 to 9 are diagrams illustrating specific examples of the relationship between the first user and the second user. In the examples illustrated in FIGS. 7 to 9, as information indicating that the first user and the second user are the same, the authentication card 60 described above and illustrated in FIG. 6 is used.

In FIG. 7, as a specific example of the relationship between the first user and the second user, a case where the first user and the second user are the same user 71 is illustrated. In the example illustrated in FIG. 7, the user 71 is authenticated in the first authentication by using the user ID of the user 71. Specifically, to be authenticated in the first authentication, the user 71 enters the user ID displayed on the authentication card 60 of the user 71 and a password, which is not illustrated in the drawing, to the user interface of the user terminal 30. Then, the first authentication is permitted, and remote connection between the user terminal 30 and the image processing apparatus 10 is established. At the same time, the user 71 is identified as the first user who has been authenticated in the first authentication.

Next, the user 71 holds the authentication card 60 over an authentication terminal apparatus 20 connected to the image processing apparatus 10. Then, the terminal apparatus 20 reads various types of information associated with the authentication card 60. The information read by the terminal apparatus 20 includes the card ID as information for identifying the second user. Thus, it is determined, based on the user ID of the user 71 as the first user who has been authenticated in the first authentication and the card ID read by the terminal apparatus 20, whether or not the second user who wishes to be authenticated in the second authentication is the user 71 who has been authenticated in the first authentication.

In the example of FIG. 7, since the second user who wishes to be authenticated in the second authentication is the user 71 as the first user who has been authenticated in the first authentication, the second authentication of the second user is permitted. As a result, the user 71 is able to perform, using the user terminal 30, a remote operation for the image processing apparatus 10 within the scope of a permission.

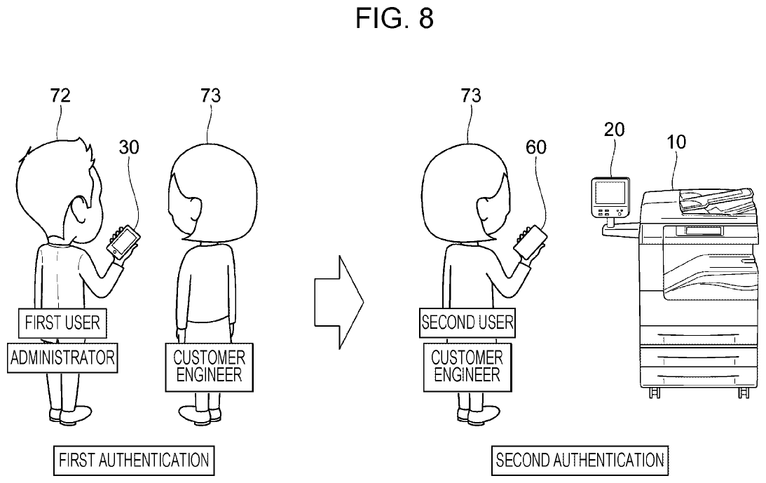

In FIG. 8, as a specific example of the relationship between the first user and the second user, a case where the second user is not the first user and different user IDs are used for the first authentication and the second authentication is illustrated. In the example illustrated in FIG. 8, a user 72 is an administrator who has an administrator permission of remote connection, and a user 73 is a customer engineer who does not have an administrator permission of remote connection.

First, the user 72 (administrator) is authenticated in the first authentication by using the user ID of the user 72. Specifically, to be authenticated in the first authentication, the user 72 (administrator) enters the user ID displayed on the authentication card 60 of the user 72 and a password, which is not illustrated in the drawing, to the user interface of the user terminal 30. Then, the first authentication is permitted, and remote connection between the user terminal 30 and the image processing apparatus 10 is established. At the same time, the user 72 (administrator) is identified as the first user who has been authenticated in the first authentication.

Next, the user 73 (customer engineer) holds the authentication card 60 of the user 73 over the authentication terminal apparatus 20 connected to the image processing apparatus 10. Then, the terminal apparatus 20 reads various types of information associated with the authentication card 60. The information read by the terminal apparatus 20 includes a card ID as information for identifying the second user. Thus, it is determined, based on the user ID of the user 72 (administrator) as the first user who has been authenticated in the first authentication and the card ID read by the terminal apparatus 20, whether or not the second user who wishes to be authenticated in the second authentication is the user 72 (administrator) who has been authenticated in the first authentication.

In the example of FIG. 8, it is determined that the first user and the second user are in a relationship in which the second user who wishes to be authenticated in the second authentication is not the user 72 (administrator) who has been authenticated in the first authentication but is the user 73 (customer engineer), but the second authentication of the user 73 (customer engineer) may be permitted. Thus, the second authentication of the user 73 (customer engineer) is permitted. As a result, the user 73 (customer engineer) is able to perform, using the user terminal 30, a remote operation for the image processing apparatus 10 within the scope of a permission.

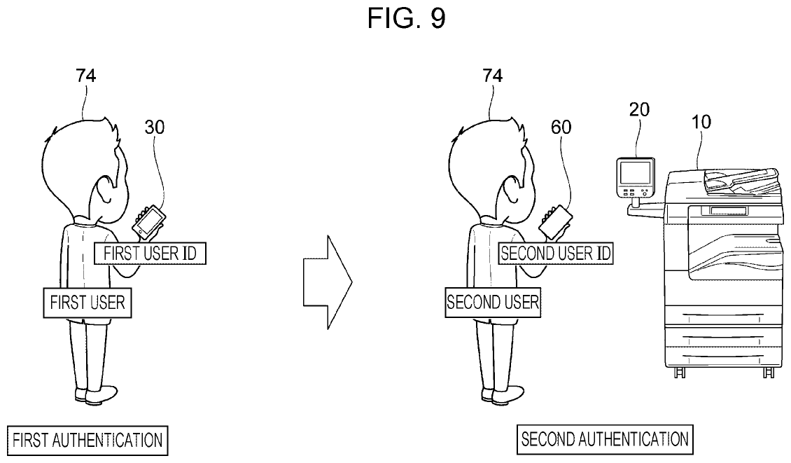

In FIG. 9, as a specific example of the relationship between the first user and the second user, a case where a user has a plurality of user IDs is illustrated. In the example illustrated in FIG. 9, a user 74 has a plurality of user IDs and wishes to be authenticated in the first authentication and the second authentication by using different user IDs.

First, the user 74 is authenticated in the first authentication by using a first user ID among the plurality of user IDs that the user 74 has. Specifically, to be authenticated in the first authentication, the user 74 enters the first user ID and a password, which is not illustrated in the drawing, to the user interface of the user terminal 30. Then, the first authentication is permitted, and remote connection between the user terminal 30 and the image processing apparatus 10 is established. At the same time, the first user who has been authenticated in the first authentication is identified as the user 74.

Next, the user 74 holds an authentication card 60 over the authentication terminal apparatus 20 connected to the image processing apparatus 10. Then, the terminal apparatus 20 reads various types of information associated with the authentication card 60. The information read by the terminal apparatus 20 includes a card ID as information for identifying the second user. Thus, it is determined, based on the first user ID of the user 74 as the first user who has been authenticated in the first authentication and the card ID read by the terminal apparatus 20, whether or not the second user who wishes to be authenticated in the second authentication is the user 74 who has been authenticated in the first authentication.

In the example of FIG. 9, although the second user who wishes to be authenticated in the second authentication is the user 74 as the first user who has been authenticated in the first authentication, the first user ID that has been used for the first authentication and a second user ID that is associated with the authentication card 60 that has been held over the terminal apparatus 20 are different. However, in the case where the first user ID and the second user ID belong to the same user, it is determined that the second authentication of the user may be permitted. Thus, the second authentication of the user 74 in the example of FIG. 9 is permitted. As a result, the user 74 is able to perform, using the user terminal 30, a remote operation for the image processing apparatus 10 within the scope of a permission.

### Other Embodiments

Although exemplary embodiments have been described above, the present disclosure is not limited to the exemplary embodiments described above. Furthermore, effects achieved by the present disclosure are not limited to effects described in the exemplary embodiments described above. For example, the configuration of the information processing system 1 illustrated in FIG. 1 and the hardware configuration of the image processing apparatus 10 illustrated in FIG. 2 are merely examples to attain advantages of the present disclosure and are not particularly limited. Furthermore, the functional configuration of the image processing apparatus 10 illustrated in FIG. 3 and the functional configuration of the user terminal 30 illustrated in FIG. 4 are merely examples and are not particularly limited. Functions for executing the entire processing described above only need to be provided in the information processing system 1, and functional configurations for implementing these functions are not limited to the examples illustrated in FIGS. 3 and 4.

Furthermore, the order of steps of the process of the image processing apparatus 10 illustrated in FIG. 5 is merely an example and is not particularly limited. Processing is not necessarily performed in the illustrated order of steps in chronological manner and may be performed concurrently or individually. Furthermore, specific examples illustrated in FIGS. 6 to 9 are merely examples and are not particularly limited.

For example, in the exemplary embodiments described above, the configuration for displaying on the user terminal 30 information (for example, a confirmation button) for allowing the first user to confirm that the first user and the second user are in a relationship in which the second user is not the first user but the second authentication of the second user may be permitted and the configuration for displaying on the image processing apparatus 10 information (for example, a confirmation button) for allowing the second user to make a confirmation have been described. However, one of the configurations may be provided or both the configurations may be provided. That is, feedback of information for confirming that the first user and the second user are in a relationship in which the second authentication of the second user may be permitted may be performed only for the first user, only for the second user, or for both the first user and the second user.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
one or more processors configured to:
   identify a first user who has been authenticated in first authentication to remotely connect, using a terminal, to an image processing apparatus and a second user who wishes to be authenticated in second authentication to use the image processing apparatus; and
   determine, based on information indicating a relationship between the identified first user and the identified second user, whether or not to permit the second authentication of the second user.
      (((2)))

The information processing system according to (((1))), wherein the one or more processors are configured to identify, based on information that has been input to the terminal and used for the first authentication and information read by an authenticating unit of the image processing apparatus, the first user and the second user.

(((3)))

The information processing system according to (((1))) or (((2))), wherein the one or more processors are configured to permit the second authentication of the second user, based on information indicating that the second user is the first user, as the information indicating the relationship.

(((4)))

The information processing system according to (((3))), wherein the information indicating that the second user is the first user is information indicating that identification information that is able to uniquely identify the first user, among a plurality of pieces of information that have been used for the first authentication, and identification information that is able to uniquely identify the second user, among a plurality of pieces of information used for the second authentication, are the same.

(((5)))

The information processing system according to (((1))) or (((2))), wherein the one or more processors are configured to permit the second authentication of the second user, based on information indicating that the first user and the second user are in a relationship in which the second user is not the first user but the second authentication of the second user may be permitted, as the information indicating the relationship.

(((6)))

The information processing system according to (((5))), wherein the one or more processors are configured to permit the second authentication of the second user, based on information indicating that the second user has confirmed that the first user and the second user are in a relationship in which the second user is not the first user but the second authentication of the second user may be permitted.

(((7)))

The information processing system according to (((6))), wherein the one or more processors are configured to display on the image processing apparatus information for allowing the second user to confirm that the first user and the second user are in a relationship in which the second user is not the first user but the second authentication of the second user may be permitted.

(((8)))

The information processing system according to (((7))), wherein the one or more processors are configured to, in a case where, at the time when the information for allowing the second user to make a confirmation is displayed on the image processing apparatus, an operation for an operation screen of the image processing apparatus is restricted due to remote connection between the image processing apparatus and the terminal, temporarily remove the restriction.

(((9))))

The information processing system according to (((5))), wherein the one or more processors are configured to permit the second authentication of the second user, based on information indicating that the first user has confirmed that the first user and the second user are in a relationship in which the second user is not the first user but the second authentication of the second user may be permitted.

(((10)))

The information processing system according to (((9))), wherein the one or more processors are configured to display on the terminal information for allowing the first user to confirm that the first user and the second user are in a relationship in which the second user is not the first user but the second authentication of the second user may be permitted.

((11))

The information processing system according to any one of (((2))) to (((10))), wherein the one or more processors are configured not to permit the second user to use the authenticating unit, in a case where the authenticating unit functions as a charging unit that is not capable of identifying the second user.

(((12)))

The information processing system according to (((10))), wherein the one or more processors are configured to, in a case where the authenticating unit functions as a charging unit that is not capable of identifying the second user, when money is inserted, display on the image processing apparatus information for allowing the second user to confirm whether or not to permit reception of the inserted money.

(((13)))

A program for causing a computer to execute:
a function for identifying a first user who has been authenticated in first authentication to remotely connect, using a terminal, to an image processing apparatus and a second user who wishes to be authenticated in second authentication to use the image processing apparatus; and
a function for determining, based on information indicating a relationship between the identified first user and the identified second user, whether or not to permit the second authentication of the second user.

What is claimed is:

1. An information processing system comprising:
one or more processors configured to:
identify a first user who has been authenticated in first authentication to remotely connect, using a terminal, to an image processing apparatus and a second user who wishes to be authenticated in second authentication to use the image processing apparatus; and
determine, based on information indicating a relationship between the identified first user and the identified second user, whether or not to permit the second authentication of the second user.

2. The information processing system according to claim 1, wherein the one or more processors are configured to identify, based on information that has been input to the terminal and used for the first authentication and information read by an authenticating unit of the image processing apparatus, the first user and the second user.

3. The information processing system according to claim 1, wherein the one or more processors are configured to permit the second authentication of the second user, based on information indicating that the second user is the first user, as the information indicating the relationship.

4. The information processing system according to claim 3, wherein the information indicating that the second user is the first user is information indicating that identification information that is able to uniquely identify the first user, among a plurality of pieces of information that have been used for the first authentication, and identification information that is able to uniquely identify the second user, among a plurality of pieces of information used for the second authentication, are the same.

5. The information processing system according to claim 2, wherein the one or more processors are configured to permit the second authentication of the second user, based on information indicating that the first user and the second user are in a relationship in which the second user is not the first user but the second authentication of the second user may be permitted, as the information indicating the relationship.

6. The information processing system according to claim 5, wherein the one or more processors are configured to permit the second authentication of the second user, based on information indicating that the second user has confirmed that the first user and the second user are in a relationship in which the second user is not the first user but the second authentication of the second user may be permitted.

7. The information processing system according to claim 6, wherein the one or more processors are configured to display on the image processing apparatus information for allowing the second user to confirm that the first user and the second user are in a relationship in which the second user is not the first user but the second authentication of the second user may be permitted.

8. The information processing system according to claim 7, wherein the one or more processors are configured to, in a case where, at the time when the information for allowing the second user to make a confirmation is displayed on the image processing apparatus, an operation for an operation screen of the image processing apparatus is restricted due to remote connection between the image processing apparatus and the terminal, temporarily remove the restriction.

9. The information processing system according to claim 5, wherein the one or more processors are configured to permit the second authentication of the second user, based on information indicating that the first user has confirmed that the first user and the second user are in a relationship in which the second user is not the first user but the second authentication of the second user may be permitted.

10. The information processing system according to claim 9, wherein the one or more processors are configured to display on the terminal information for allowing the first user to confirm that the first user and the second user are in a relationship in which the second user is not the first user but the second authentication of the second user may be permitted.

11. The information processing system according to claim 2, wherein the one or more processors are configured not to permit the second user to use the authenticating unit, in a case where the authenticating unit functions as a charging unit that is not capable of identifying the second user.

12. The information processing system according to claim 10, wherein the one or more processors are configured to, in a case where the authenticating unit functions as a charging unit that is not capable of identifying the second user, when money is inserted, display on the image processing apparatus information for allowing the second user to confirm whether or not to permit reception of the inserted money.

13. An information processing method comprising:
identifying a first user who has been authenticated in first authentication to remotely connect, using a terminal, to an image processing apparatus and a second user who wishes to be authenticated in second authentication to use the image processing apparatus; and
determining, based on information indicating a relationship between the identified first user and the identified second user, whether or not to permit the second authentication of the second user.

14. A non-transitory computer readable medium storing a program causing a computer to execute a process comprising:
identifying a first user who has been authenticated in first authentication to remotely connect, using a terminal, to an image processing apparatus and a second user who wishes to be authenticated in second authentication to use the image processing apparatus; and
determining, based on information indicating a relationship between the identified first user and the identified second user, whether or not to permit the second authentication of the second user.
